(19) United States
(12) Patent Application Publication
(10) Pub. No.: US 2014/0019861 A1
(43) Pub. Date: Jan. 16, 2014

(54) GRAPHICAL USER INTERFACE FOR NAVIGATING AUDIBLE CONTENT

(71) Applicant: Sight8, Inc., San Anselmo, CA (US)

(72) Inventors: Tanya Rieger Laramie, San Anselmo, CA (US); Brian Keith Laramie, San Anselmo, CA (US)

(21) Appl. No.: 13/919,840

(22) Filed: Jun. 17, 2013

Related U.S. Application Data
(60) Provisional application No. 61/671,480, filed on Jul. 13, 2012.

(51) Int. Cl. G06F 3/16

(52) U.S. Cl. CPC G06F 3/167
USPC 715/716

(57) ABSTRACT

A graphical user interface for a selecting audio content by decade and/or year along a timeline is disclosed. The interface facilitates easy and fast audio selection by decade or year. The graphical user interface can be accessed through a website or application that can be downloaded onto a computing apparatus.

### CROSS REFERENCE TO RELATED APPLICATIONS

This patent application claims the priority benefit of U.S. provisional application number 61/671,480 filed Jul. 13, 2012 and entitled, “Graphical User Interface for Navigating Audible Content.” The aforementioned application is incorporated herein by reference.

### BACKGROUND

1. Field of the Invention

The present invention generally relates to graphical user interfaces (GUIs) and more specifically to a GUI for navigating and selecting from multiple streams of audible content.

2. Description of the Related Art

As the volume of content available for popular consumption continues to increase exponentially, it has become necessary to provide more simple and enjoyable ways for people to access and experience audible content as well as historical information.

Currently, examples of computing apparatuses include personal computers, including desktops and laptops, tablet computers such as iPads, and smart phones, including Apple's iPhone®, Google's Android® phone, and Symbian® phones. These computing apparatuses have extremely user-friendly interfaces, for enabling easy and quick interaction with users thereof. Most of these apparatuses incorporate touch-sensitive screens for receiving users' inputs and facilitate smooth user interaction.

However, there is no easy way for a user to identify and select audible content by date or decade or by historical event in an easy to use GUI. Music, for example, is either downloaded song by song, album by album or is streamed from a radio station.

There exists a need for a better and highly congenial graphical user interface for an audible system wherein an audible stream is chosen by date, for example, year or decade.

### SUMMARY OF THE PRESENTLY CLAIMED INVENTION

One embodiment of the present invention comprises a computing apparatus for navigating audio content within a graphical user interface. The computing apparatus includes a display and a computing hardware configured to execute a software product. The software product generates and renders a graphical user interface on the display. The graphical user interface facilitates user interaction and the computing hardware, graphical user interface, and the software product are implemented on an application or on an Internet website that has audio content. The computer hardware presents a timeline having one or more tick marks on the graphical user interface, allow a selection of one or more of the tick marks, detect the selection of one of the tick marks from the timeline, and stream audio content corresponding to the selected tick mark on the graphical user interface. The tick marks of the graphical user interface correspond to a predetermined time period on the timeline and the audio content corresponds to the predetermined time period selected along the timeline.

Another embodiment of the present invention is a method of facilitating user interactions with a graphical user interface. The graphical user interface is generated and rendered on the display of a computing apparatus, by executing a software product on a computing hardware of the computing apparatus. The method includes rendering a timeline having one or more tick marks within the graphical user interface, detecting a selection of one of the tick marks, and streaming audio content corresponding to the selected tick mark on the graphical user interface. The tick marks of the graphical user interface correspond a predetermined time period along the timeline and the audio content corresponds to the predetermined time period selected along the timeline.

Embodiments of the method can be performed by a computing device in communication with a client or by the client itself. The method can also be performed by a processor executing a program contained on a computer readable storage medium.

Further scope of applicability of the present invention will be set forth in part in the detailed description to follow, taken in conjunction with the accompanying drawings, and in part will become apparent to those skilled in the art upon examination of the following.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is an exemplary view of one graphical user interface;

FIG. 2 is an exemplary view of another graphical user interface;

FIG. 3 is an exemplary view of another graphical user interface;

FIG. 4 is an exemplary view of another graphical user interface;

FIG. 5 is a schematic flow chart diagram showing a method of facilitating user interactions with a graphical user interface for streaming audio content; and

FIG. 6 illustrates an exemplary computing system that may be used to implement an embodiment of the present invention.

### DETAILED DESCRIPTION

Embodiments of the present invention are performed on a computing apparatus that includes a display and a computing hardware configured to execute a software product. The software product preferably generates and renders a graphical user interface on the display surface. The graphical user interface facilitates user interaction and the computing hardware, graphical user interface, and the software product are implemented on an application or on an Internet website that has audio content. The application or Internet website allow a user to navigate audio content within a graphical user interface

Embodiments of the present invention pertain to a graphical user interface (GUI) for a selecting audio content by decade and/or year along a timeline, for facilitating easy and fast audio selection by decade or year. The GUI of an embodiment of the present invention can be accessed through a website or application that can be downloaded onto a computing apparatus, such as but not limited to, a personal computer, including a desktop or laptop, a tablet, or a smart phone. An audio selection can include, but is not limited to, music, radio programs, historical sporting events, historical readings, dramatic readings, historical events, combinations thereof and the like. In another embodiment of the present invention, the GUI includes both audio and video content.

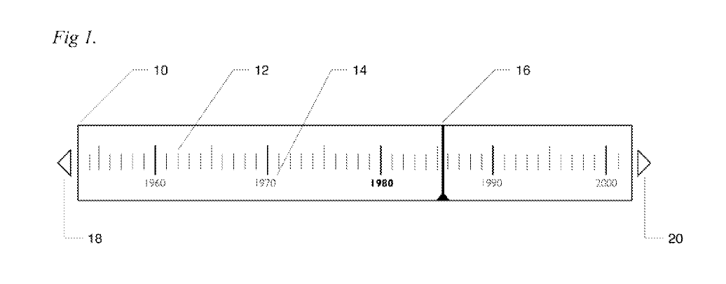

FIG. 1 is an exemplary view of a graphical user interface (GUI) that allows a user to navigate to and select from audio content curated along a substantially horizontal time line. The GUI of FIG. 1 includes dial 10 that displays incremental tick marks 12. Groupings of incremental tick marks 12 are identified by label 14 which correlates to a time period, such as, for example, a year or a decade.

Still referring to FIG. 1, the user can select a stream (source) of audible content (e.g., music, historical recordings, combinations thereof and the like) that is of or relating to a specific time period. The user clicks on label 14 using a mouse, arrow keys, or a trackball or other input apparatus, or if using a touch-enabled device, making a tap or swipe gesture 22. Users can slide dial 10 to move left/backward 18 or right/forward 20 on the time line. The currently selected time period is indicated by needle 16.

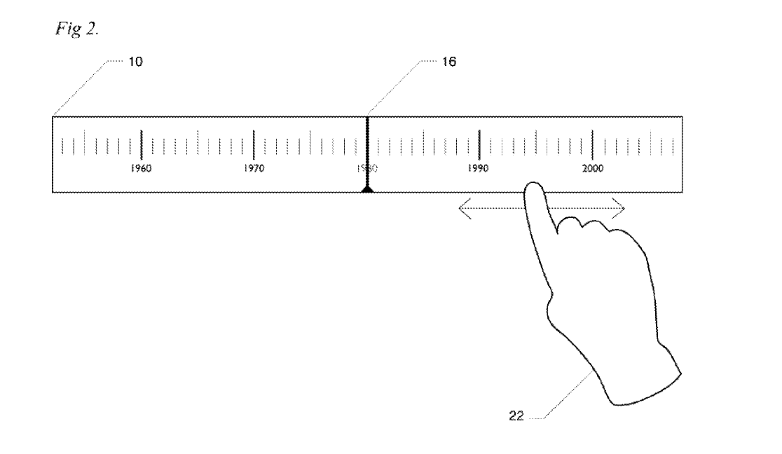

FIG. 2 is an exemplary view of another GUI that allows a user to navigate to and select from audio content curated along a timeline using a touch screen device. In the example of FIG. 2, the user is able to slide dial 10 backward or forward with a tap or swipe gesture 22. Needle 16 indicates the currently selected time period which remains fixed at the approximate center of dial 10.

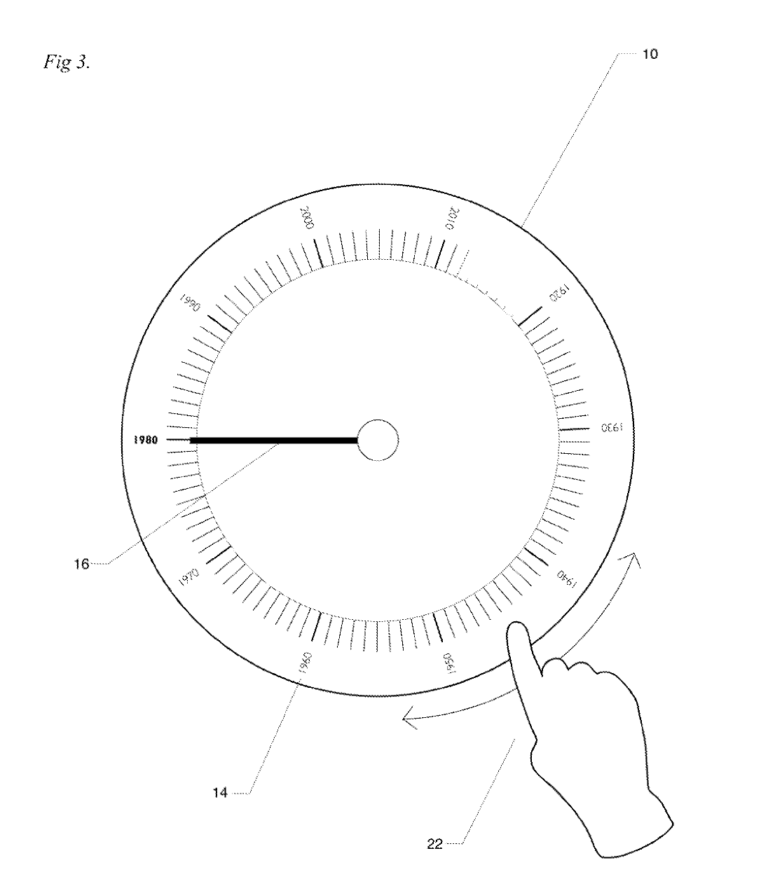

FIG. 3 is an exemplary view of yet another GUI. The embodiment shown in FIG. 3 allows a user to navigate to and select from audio content curated along a timeline. In this example, dial 10 is substantially circular or round in shape. The currently selected time period is represented by needle 16 that is fixed along a horizontal axis of dial 10. The user rotates dial 10 backward or forward by clicking label 14 using a mouse, arrow keys, or trackball or other input device or, if using a touch-enabled device, making a tap or swipe gesture 22.

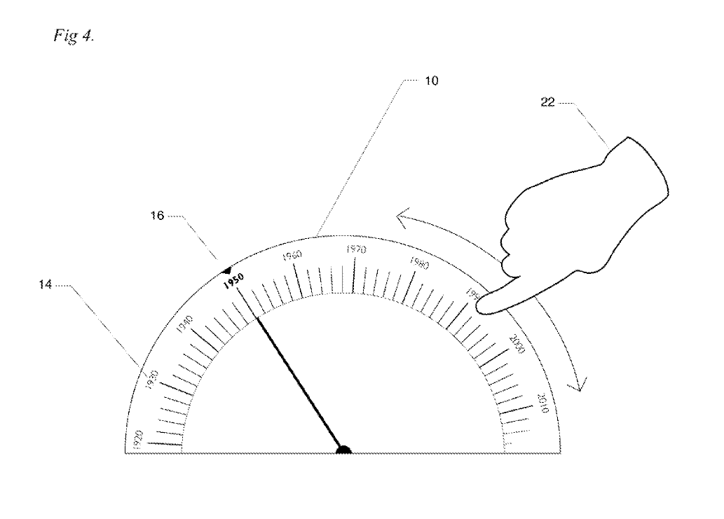

FIG. 4 is an exemplary view of another GUI that allows users to navigate to and select from audio content curated along a timeline. In this example, dial 10 is shown as a half-circle. The currently selected time period is represented by needle 16. The user is able to rotate dial 10 backward and forward by clicking label 14 or using one or more arrow keys, if using a touch-enabled device, making a tap and/or swipe gesture 22.

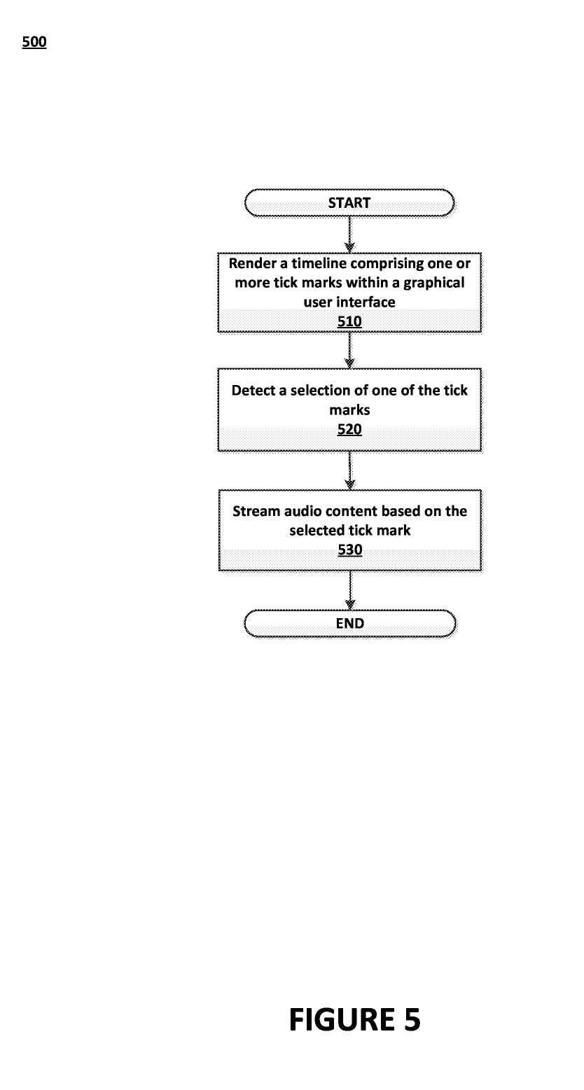

FIG. 5 is a schematic flow chart diagram showing a method 500 for facilitating user interactions with a graphical user interface for streaming audio content. This method including rendering a timeline with one or more tick marks within the graphical user interface 510, detecting a selection of one of the tick marks 520 and streaming audio content corresponding to the selected tick mark 530.

One embodiment of the present invention includes a GUI for selecting audio content wherein the audio content streams a variety of audio selections ordered randomly. In an alternative embodiment, the audio content is listed for each decade so that once a user slides dial 10 to a decade, the user selects particular audio streams from the decade chosen. In yet another embodiment of the present invention, a user selects a year by sliding dial 10 and then chooses from a list of music, historical events or newscasts, sporting events, combinations thereof or the like. The user chooses a selection by merely tapping on the selection of choice. When listening to an audio selection, a user can simultaneously browse other websites or applications on the electronic apparatus, by opening another tab or window on a browser.

Another embodiment of the present invention includes a GUI for selecting a radio service that curates and transmits over a century of recorded sound. The GUI resembles a traditional radio receiver with decades instead of MHz on the dial. Listeners tune in a frequency and travel between the early 1900s through today, hearing voices from the past to the present, both familiar and unknown.

In a non-limiting example, a website or application is provided wherein a user can navigate to different audible contents by decade. There is a different string of music at each decade and different audible content at each year within a decade. For example, at the turn of each decade there is a unique stream of audio from that period. If a user drags the timeline to 1940, for example, the indicator changes and an icon appears to let the user know that a signal is being received from the 1940s. In addition to the decade broadcasts, there can also be a featured programming on-demand. For example, on 1923 a user can listen to a Will Rogers recording from that year.

The advantages of the present invention include, without limitation, dial 10 that is simple to understand and easy to use. This combined with the method of curating audio content along a timeline creates a user experience that has educational and entertainment value.

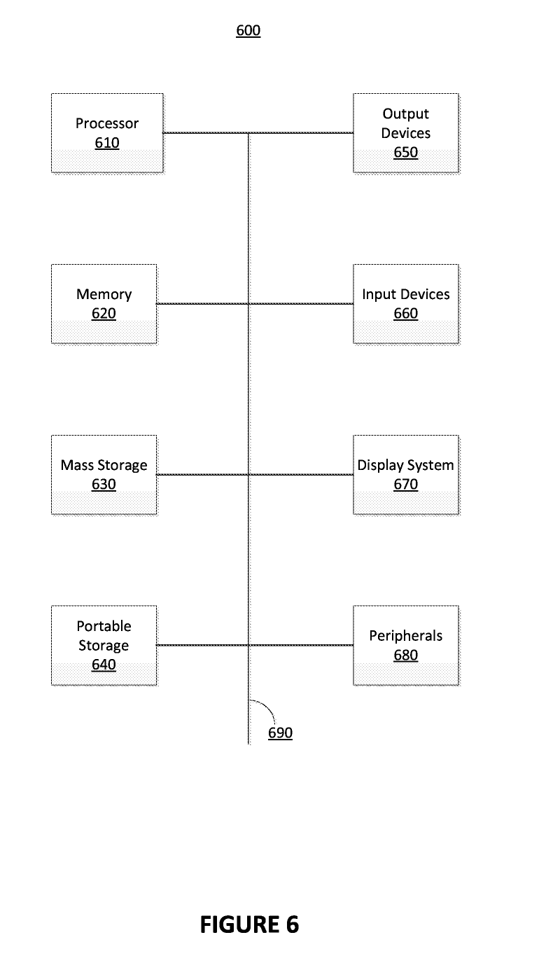

FIG. 6 illustrates an exemplary computing system 600 that may be used to implement an embodiment of the present invention. System 600 of FIG. 6 may be implemented in the context of facilitating user interaction and allowing a user to navigate to and select from audio content curated along a time line. The computing system 600 of FIG. 6 includes one or more processors 610 and memory 610. Main memory 610 stores, in part, instructions and data for execution by processor 610. Main memory 610 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 610 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 610.

Portable storage device 640 operates in conjunction with a portable non-volatile storage medium, such as a floppy disk, compact disk or digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD) or other suitable display device. Display system 670 receives textual and graphical information, and processes the information for output to the display device.

Peripherals 680 may include any type of computer support device to add additional functionality to the computer system. For example, peripheral device(s) 680 may include a modem or a router.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A computing apparatus for navigating audio content within a graphical user interface comprising:
a display; and
a computing hardware configured to execute a software product,
wherein executing the software product generates and renders a graphical user interface on the display, the graphical user interface being configured to facilitate user interaction, the computer hardware being configured to:
present a timeline comprising one or more tick marks on the graphical user interface;
enable a selection of one or more of the tick marks on the graphical user interface;
detect the selection of one of the tick marks from the timeline; and
stream audio content corresponding to the selected tick mark on the graphical user interface, wherein the tick marks of the graphical user interface correspond to a predetermined time period on the timeline and wherein the audio content corresponds to the predetermined time period selected along the timeline.

2. The apparatus of claim 1 wherein the selection comprises a swipe, click or tap motion over the graphical user interface.

3. The apparatus of claim 1 wherein the timeline comprises a dial.

4. The apparatus of claim 1 wherein the timeline comprises a needle to indicate a selected predetermined time period.

5. The apparatus of claim 1 wherein the predetermined time period comprises a year.

6. The apparatus of claim 1 wherein the predetermined time period comprises a decade.

7. A method of facilitating user interactions with a graphical user interface comprising:
generating and rendering the graphical interface on a display of a computing apparatus, by executing a software product on a computing hardware of the computing apparatus;
rendering a timeline comprising one or more tick marks within the graphical user interface;
detecting a selection of one of the tick marks; and
streaming audio content corresponding to the selected tick mark on the graphical user interface, wherein the tick marks of the graphical user interface correspond a predetermined time period along the timeline and wherein the audio content corresponds to the predetermined time period selected along the timeline.

8. The method of claim 7 wherein the selection comprises a swipe, click or tap motion over the graphical user interface.

9. The method of claim 7 wherein the timeline comprises a dial.

10. The method of claim 7 wherein the timeline comprises a needle to indicate a selected predetermined time period.

11. The method of claim 7 wherein the predetermined time period comprises a year.

12. The method of claim 7 wherein the predetermined time period comprises a decade.

13. A computer readable storage medium having embodied thereon a program, the program being executable by a processor to perform a method for facilitating user interactions with a graphical user interface, the method comprising:
generating and rendering the graphical interface on a display of a computing apparatus, by executing a software product on a computing hardware of the computing apparatus;
rendering a timeline comprising one or more tick marks within the graphical user interface;
detecting a selection of one of the tick marks; and
streaming audio content corresponding to the selected tick mark on the graphical user interface, wherein the tick marks of the graphical user interface correspond a predetermined time period along the timeline and wherein the audio content corresponds to the predetermined time period selected along the timeline.

14. The computer readable storage medium of claim 13, wherein the selection comprises a swipe, click or tap motion over the graphical user interface.

15. The computer readable storage medium of claim 13, wherein the timeline comprises a dial.

16. The computer readable storage medium of claim 13, wherein the timeline comprises a needle to indicate a selected predetermined time period.

17. The computer readable storage medium of claim 13, wherein the predetermined time period comprises a year.

18. The computer readable storage medium of claim 13, wherein the predetermined time period comprises a decade.
